(19) United States
(12) Patent Application Publication
(10) Pub. No.: US 2010/0121789 A1
(43) Pub. Date: May 13, 2010

(54) INTERACTIVE APPARATUS FOR ASSISTING IN ENCOURAGING OR DETERRING OF AT LEAST ONE PREDETERMINED HUMAN BEHAVIOR

(76) Inventors: Vladimir Bednyak, Vernon Hills, IL (US); Alla Altshuler, Vernon Hills, IL (US)

Correspondence Address: EDWARD ETKIN, ESQ., Law Office of Edward Etkin, PC, 228 West End Avenue, Suite A, Brooklyn, NY, 11235, US

(21) Appl. No.: 12/617,684

(22) Filed: Nov. 12, 2009

Related U.S. Application Data
(60) Provisional application No. 61/113,340, filed on Nov. 11, 2008.

(51) Int. Cl. G06F 17/20; G06N 5/02

(52) U.S. Cl. 706/11

(57) ABSTRACT

The present invention provides a portable, inexpensive, and easy to use apparatus capable of providing one or more types of social intervention (e.g., deterring, encouraging, etc.) to a person in an interactive manner, in order to influence (or to assist in influencing) one or more of that person's behavior(s), in a corresponding predetermined manner. Advantageously, the inventive interactive apparatus may provide encouraging social interaction to motivate a person to engage in one or more positive desirable behaviors (exercise, etc.), and/or provide deterring social interaction to discourage the person from engaging in one or more predetermined detrimental behaviors (such as overeating, eating large quantities of unhealthy foods, smoking, etc.). In one inventive embodiment, the novel interactive apparatus may be configured to provide encouraging messages to increase the likelihood of utilization of another helpful product or service, thereby enhancing the effectiveness thereof. The apparatus of the present invention is preferably implemented as a doll, statuette, action figure, animal or other fanciful character-type toy, to enhance the social interaction experience with one or more persons whose behavior is to be encouraged or deterred.

### CROSS REFERENCE TO RELATED APPLICATIONS

The present patent application claims priority from the commonly assigned co-pending U.S. provisional patent application 61/113,340 entitled “INTERACTIVE APPARATUS FOR ASSISTING IN ENCOURAGING OR DETERRING OF AT LEAST ONE PREDETERMINED HUMAN BEHAVIOR”, filed Nov. 11, 2008.

### FIELD OF THE INVENTION

The present invention relates generally to devices for encouraging and/or, deterring one or more human predetermined behaviors, and more particularly to a portable interactive electronic device capable of audio output in response to I S one or more conditions relating to the human behavior to be encouraged and/or deterred, and that is implemented as a doll, statuette, action figure, animal or other fanciful character-type toy, or any other recognizable or abstract object, to enhance the interaction experience with one or more persons whose behavior is to be encouraged or deterred.

### BACKGROUND OF THE INVENTION

In the course of their daily lives, people engage in a variety of behaviors that may have a negative impact on their health, wellbeing, social life and on the people with whom they live, spend time, or otherwise interact. These “detrimental behaviors” may be engaged in by choice, or they may result from a person's force of habit, from physiological or psychological addiction, from a health-related condition, from social influences (peer pressure, etc.), from a mental or personality disorder, or from a combination of one or more of the above factors.

Examples of such detrimental behaviors include but are not limited to: overeating, consuming large quantities of unhealthy foods, eating at inappropriate times, excessive alcohol consumption, recreational drug and/or drug-substitute use, smoking, etc. These detrimental behaviors are particularly problematic when engaged in by children, teenagers, older people, and persons living by themselves. While in most cases cessation of the detrimental behavior is the ultimate goal, in many situations, the detrimental behaviors can be countered by and effectively neutralized by one or more corresponding positive behaviors. For example, the detrimental behavior of overeating can be effectively countered by a good exercise program, while the desire to smoke can be at least partially dulled or reduced by chewing gum or similar “substitutes”.

Naturally, a wide variety of approaches have been taken over the years to deter detrimental human behaviors, or to encourage or motivate positive ones: These approaches range from social intervention (counseling, psychotherapy, motivational groups (such as AA)), to medical intervention (weight reduction/abatement surgery, prescription medication, detoxification, etc.), to provision and utilization of various products designed to assist a person in moving away from a negative behavior (nicotine gum/patches for smoking, specially prepared pre-packaged healthy meals or preconfigured healthy meal plans (e.g., Weight Watchers, Nutrasystem, etc.)), and/or products for motivating the person to engage in positive behavior such as exercise machines, instructional videos, talking weight scales, body fat meters, electronic personal exercise aides (pocket calorie meters, pedometers, etc.).

While the various above-described approaches have varying degrees of effectiveness and success from person to person, it is well established that behavior—affecting products are significantly more effective when coupled with social intervention.

Unfortunately, for a variety of reasons, many people do not have the benefit of a spouse, family member or a friend that are always available to provide the needed social intervention. In other situations, spouses and family members may feel uncomfortable in constantly discouraging on or more of a person's detrimental behaviors, or may avoid frequent encouragement of their positive behaviors, as they don't want to negatively affect their personal relationship with the individual in question by being perceived as nagging, harassing; or otherwise annoying, or by creating a situation where their efforts are met with resentment from the targeted individual.

Young children and teenagers present another set of problems because either their parents are afraid of being to hard on them when they are young (to avoid long term psychological issues, and to avoid confrontations with their child), or with respect to teenagers, many parents already have a very volatile and problematic relationship for other reasons, and do not want to make things worse by placing additional social pressure on their teenager to influence their behavior.

Furthermore, as a result of the above-described factors, a wide variety of potentially effective approaches and/or products for influencing human behavior in a desirable manner (i.e., deterring detrimental behavior and encouraging positive behavior), are rendered far less effective than their potential due to the lack of a social motivational or deterring component in conjunction with their utilization.

It would thus be desirable to provide a portable, inexpensive, and easy to use apparatus capable of providing one or more types of social intervention (e.g., deterring, encouraging, etc.) to a person in an interactive manner, to influence one or more of that person's behavior(s), in a corresponding predetermined manner. It would further be desirable to provide an interactive apparatus capable of exerting one or more types of social intervention to enhance the effectiveness of one or more other behavior-influencing approaches and/or products.

### SUMMARY OF THE INVENTION

The present invention provides a portable, inexpensive, and easy to use apparatus capable of providing one or more types of social intervention (e.g., deterring, encouraging, etc.) to a person in an interactive manner, in order to influence (or to assist in influencing) one or more of that person's behavior(s), in a corresponding predetermined manner.

Advantageously, the inventive interactive apparatus may provide encouraging social interaction to motivate a person to engage in one or more positive desirable behaviors (exercise, etc.), and/or provide deterring social interaction to discourage the person from engaging in one or more predetermined detrimental behaviors (such as overeating, eating large quantities of unhealthy foods, smoking, etc.).

In one inventive embodiment, the novel interactive apparatus may be configured to provide encouraging messages to increase the likelihood of utilization of another helpful product or service, thereby enhancing the effectiveness thereof. The inventive apparatus is preferably implemented as a doll, statuette, action figure, animal or other fanciful character-type toy, to enhance the social interaction experience with one or more persons whose behavior is to be encouraged or deterred, but may also be implemented in any other suitable form or configuration without departing from the spirit of the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference characters denote corresponding or similar elements throughout the various figures:

FIG. 1 is an exemplary diagram of an exemplary embodiment of the inventive character-themed interactive apparatus for providing one or more types of social intervention to a person when one or more predefined conditions are met in order to influence one or more of that person's behavior(s), in a corresponding predetermined manner; and

FIG. 2 is an exemplary diagram of an exemplary embodiment of electronic functional components at least partially implemented in the inventive apparatus of FIG. 1 that enable one or more advantageous functions thereof.

### DETAILED DESCRIPTION OF PREFERRED EMBODIMENTS

The present invention provides a portable, inexpensive, and easy to use apparatus capable of providing one or more types of social intervention (e.g., deterring, encouraging, etc.) to a person in an interactive manner, in order to influence (or to assist in influencing) one or more of that person's behavior(s), in a corresponding predetermined manner. Thus, the inventive interactive apparatus may provide encouraging social interaction to motivate a person to engage in one or more positive desirable behaviors (exercise, etc.), and/or provide deterring social interaction to discourage the person from engaging in one or more predetermined detrimental behaviors (such as overeating, eating large quantities of unhealthy foods, smoking, etc.). In summary, in its preferred embodiment, the inventive apparatus accomplishes the above task by playing back one or more specially configured and stored audio clips comprising one or more encouraging and/or discouraging messages in response to one or more predefined trigger conditions (such as a certain time of day being reached, a refrigerator door being opened, or being opened a certain amount of times over a predetermined period of time. Optionally the trigger conditions may include the absence of one or more events—for example if an exercise machine has not been turned on for a certain period of time, the apparatus can play back a message encouraging the person to use the machine

As shown in the above example, in one embodiment of the present invention, the novel interactive apparatus may be configured to provide encouraging messages to increase the likelihood of utilization of another helpful product or service, thereby enhancing the effectiveness thereof. Thus, the apparatus can remind a person to eat their specially prepared healthy meals at the optimal time, or may remind a person that they have not used their treadmill in several days.

The apparatus of the present invention is preferably implemented as a doll, statuette, action figure, animal or other fanciful character-type toy, to enhance the social interaction experience with one or more persons whose behavior is to be encouraged or deterred. However, the inventive device may be implemented in a form that differs from that of a character or other type of creature, without departing from the spirit of the invention. For example, the inventive device may be a specific recognizable object (such as representation of a food item,) or it may be an abstract object.

Advantageously, in order to significantly enhance the “social experience”, and to provide a context in delivering at least one behavior-influencing message to a person, each of the at least one message that may be delivered by the apparatus is preferably configured to be humorous and/or memorable. Examples of such messages include, but are not limited to:
I'm Doctor Tighten-Belt. Follow my advice and You'll be swell.
Hey! The Treadmill is one door over!
If you are looking for relief, there another way to handle it.
Opening it again? Be careful—you are entering a dangerous zone!
Uh oh! Here you are, there are better foods than ice cream!
Don't feel guilty—just eat healthy!
You are stronger than your appetite
It is not time for lunch, it is not time for dinner—its time to exercise
You are not a cave man hunting for food, the food is hunting for you!
Are you looking for an apple or for salad?
You'd look so much better if you would not eat your comfort food in front of the TV
You will be able to buy that great outfit if you stop eating after 7 p.m.!

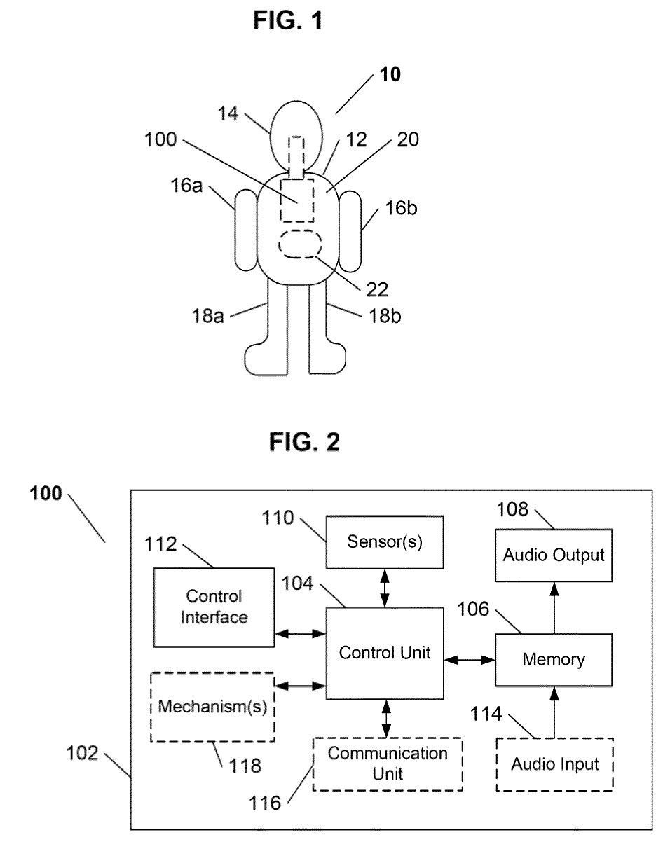

Referring now to FIG. 1, the inventive apparatus 10 is shown by way of example as a humanoid FIG. 12, which is preferably a doll or an action figure that is preferably configured and presented in manner appropriate for the type of behaviors it is intended to encourage and/or discourage. The FIG. 12 includes a body 20, a head 14, and limbs 16a to 18b, and also includes electronic functional components 100 (shown in FIG. 2) that may be placed within the body 20 and/or the head 14, or alternately may be positioned, or dispersed among, the other portions thereof. Preferably, the apparatus 10 also includes a releasable attachment element 22 configured for enabling the apparatus to be releasably positioned at various desired heights, and on a variety of surfaces (such as a refrigerator door, a bathroom mirror, etc.). The element 22 may include one or more of the following: at least one magnet (in which case the electronic component 100 would need to be shielded therefrom, a releasable adhesive, a two-part Velcro connector with one Velcro surface being part of the body 20, and the other affixed to a surface, one or more suction cups, etc.

It should be noted that while the exemplary embodiment of the inventive interactive apparatus is shown and described as being in generally humanoid shape (for example it may be implemented as a conventional doll, action figure, a statuette or equivalent, that may be at least partially rigid, or it may be flexible or fully or partially articulated), the inventive apparatus may be implemented as any character-type “toy” such as an anthropomorphic animal, a movie or cartoon character, a robot, an alien or any other figure that could be expected to deliver one or more behavior influencing messages in form of a social interaction, as a matter of design choice without departing from the spirit of the invention. However, as was noted above, the inventive apparatus 10 may be implemented in any desired form that differs from that of a specific character or other type of anthropomorphic animal, or other creature, without departing from the spirit of the invention. For example, the inventive device may be a specific recognizable object (such as representation of a food item, by way of example, a hamburger), or it may be an abstract object, such as a plain or decorated geometric shape (e.g., a cube, a sphere, a pyramid, etc.). Similarly, the apparatus 10 may be of any desired size from a few inches high to one foot high or larger.

Referring now to FIG. 2, an exemplary embodiment of the functional electronic component 100 is shown in an optional housing 102. The functional component 100 preferably includes the elements 104 to 112 for enabling operation of the Apparatus 10, and may also include one or more optional components:
Optional audio input 114 for enabling one or more individuals to record their own audio messages in addition to, or instead of, the predetermined stored at least one message;
Optional communication unit 116 (for example Bluetooth or a wi-fi device) to enable the apparatus 10 to be remotely configured, given one or more personality profiles (for example with sets of preconfigured messages), and for enabling the apparatus 10 to perform other desired tasks such as re-ordering a person's weight watchers meals over the Internet in response to a voice prompt therefrom;
Optional mechanism(s) 118 for enabling the apparatus 10 to perform physical tasks or to be animatronically animated (e.g. turning its head 14, waiving one or both of the arms 16a, 16b, etc.;
Optional at least one activation/trigger system component that is operable to activate one or more of the other apparatus 10 features (such as message delivery), which may include, but is not limited to: a timer (self-contained or connected to an external timer, such as that of an exercise machine (e.g., a treadmill), vibration or other motion or mechanical disturbance sensor, an optical/light sensor (that may be activated, by way of example, when a refrigerator door is opened), an electromagnetic field sensor, or even a biometric/visual recognition sensor, in which case the apparatus 10 would be operable to recognize, and react to, specific individuals. In an alternate embodiment of the present invention, the apparatus 10 may be further configured with a control system that, coiled with the at least one activation/trigger system may be capable of acting selectively, and to intelligently determine which message and/or messages are appropriate for a particular person triggering the apparatus 10 (e.g., by activating one or more of its sensors), such determination being based on a predetermined criteria and/or programming for example taking into account a person's height, weight, a ratio thereof, and possibly other factors; and
Optional message control system operable to (1) deliver more than one of the messages in a pre-defined, or in a user-selectable sequence, (2) select/deliver messages based on time of day and/or day of week, and/or on the season, and/or (3) select/deliver messages based on one or more other factors such as previous time of activation, previous messages delivered, etc.

In various alternate exemplary embodiments thereof, the inventive apparatus 10 may optionally include one or more of the following features:
Two or more of the apparatus 10 may optionally be operable to act separately and/or independently from one another and may be separable or separated from the main unit and in communication with one another. For example, the apparatus 10 may have its main portion positioned outside a refrigerator but may include a separate sensor that is placed therein, but that serves as an “extension” of the apparatus. Optionally, or more such separate or separable components may be built into yet another device by its manufacturer. For example, a refrigerator may come pre-installed with a sensor component compatible with the apparatus 10, and capable of communication and/or interaction therewith;
Optionally, the apparatus 10 may be integrated into another product and configured to be difficult or virtually impossible to remove therefrom, without destroying the other product (e.g., a device built into a pack of cigarettes advocating the cessation of smoking); and
In another embodiment thereof, the apparatus 10 may include conventional sources of power (such as batteries) that may be rechargeable or disposable, or it may have one or more components for generating additional and/or primary power, such as a motion-based electrical generator, or a solar-energy cell collector.

Thus, while there have been shown and described and pointed out fundamental novel features of the inventive system and method as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A portable interactive electronic device for influencing one or more predefined human behaviors in a predetermined manner, comprising:
housing means configured as a talking-capable character figure; and
means for providing audio output of one or more behavior-influencing messages to a person, in response to one or more conditions relating to the one or more predefined behaviors to be encouraged and/or deterred.
